(19) United States
(12) Patent Application Publication
(10) Pub. No.: US 2025/0278565 A1
(43) Pub. Date: Sep. 4, 2025

(54) COMPUTER-READABLE RECORDING MEDIUM HAVING STORED THEREIN INFORMATION PROCESSING PROGRAM, METHOD FOR INFORMATION PROCESSING, AND INFORMATION PROCESSING DEVICE

(71) Applicant: Fujitsu Limited, Kawasaki-shi (JP)

(72) Inventors: Tatsuya HIRAOKA, Kawasaki (JP); Tomoya IWAKURA, Kawasaki (JP)

(73) Assignee: Fujitsu Limited, Kawasaki-shi (JP)

(21) Appl. No.: 19/039,912

(22) Filed: Jan. 29, 2025

(30) Foreign Application Priority Data
Feb. 29, 2024 (JP) 2024-030416

(51) Int. Cl. G06F 40/284

(52) U.S. Cl. CPC G06F 40/284

(57) ABSTRACT

A method including: in training a word splitter with a training data set including data pieces each associating a letter string data piece and a class data piece representing one of classes that the letter string data piece pertains with each other, the word splitter outputting split letter string data including letter strings obtained by splitting an inputted letter string data piece, the split letter string data serving as input data to be inputted into a machine-learning model that performs an inference process, training the word splitter based on biasedness of occurrence frequency in the classes for each of a first letter strings included in pieces of the split letter string data being obtained by inputting the letter string data piece into the word splitter and by splitting the letter string data piece in respective different splitting patterns corresponding to the letter string data piece.

### CROSS-REFERENCE TO RELATED APPLICATION

This application is based upon and claims the benefit of priority of the prior Japanese Patent application No. 2024-030416, filed on Feb. 29, 2024, the entire contents of which are incorporated herein by reference.

### FIELD

The embodiment discussed herein relates to a computer-readable recording medium having stored therein an information processing program, a method for information processing, and an information processing device.

### BACKGROUND

A natural language processing (NLP) using a machine learning model sometimes executes a process of splitting a text into finer units, for example, tokens. The text is an example of an input into a machine learning model. A token is one or more letter strings (phrase or word) obtained by splitting the letter string data at one or more positions.

For example, splitting a text “AJIHAKIRAIJANAI” in a certain way of delimiting obtains the tokens of “AJIHA”, “KIRAI”, “JA”, and “NAI”. Throughout this specification, Japanese characters of “Kanji” and “Hiragana” are expressed in “Hepburn romanization” for convenience. As another example, splitting the text “_not_bad_taste” (the underscore “_” indicates a half-width space as one letter) in a certain way of delimiting obtains tokens “_not”, “_bad”, “_tas”, and “the” are obtained.

Hereinafter, for convenience, a token is sometimes referred to as “word.” “Words” may include, for example, tokens of common words such as “KIRAI”, “_not”, and also tokens of subwords such as “JA”, “_tas”, and “the”. The process of splitting letter string data into tokens may be referred to as “word-splitting”, “word-segmentation” or “tokenization”.

The manner of delimiting a text in tokenization, which means a tokenizing pattern, may affect the performance of natural language processing using a machine learning model, e.g., quality (for example, precision, accuracy, or the like) of the inference result outputted from the machine learning model.

For example, tokenization by a tokenizer (word splitter) may be performed as an upstream task (pre-processing) and the tokenized text obtained by the tokenization may be used in a downstream task (post-processing). In the downstream process, for example, an inference process is performed with a trained machine learning model (hereinafter sometimes referred to as “downstream model”) using the tokenized text as input data. In such a process, varying the tokenizing pattern of tokenization may enhance the performance of the natural language processing, eliminating the requirement for adjusting parameters of the downstream model.

For example, an approach has been known which simultaneously optimizes (adjusts) the tokenization and the downstream model by activating the tokenizer and the downstream model in parallel. This method optimizes a tokenizer by, for example, inputting a tokenized text obtained by inputting input data containing multiple texts into the tokenizer and feeding the result of training the downstream model back to the tokenizer.

For example, a related art is disclosed in Japanese Laid-Open Patent Publication No. 2022-077202.

### SUMMARY

According to an aspect of the embodiments, a non-transitory computer-readable recording medium has stored therein an information processing program that causes a computer to execute a process including: in training a word splitter with a training data set including a plurality of training data pieces each associating a letter string data piece and a class data piece representing one of a plurality of classes that the letter string data piece pertains with each other, the word splitter outputting split letter string data including a plurality of letter strings obtained by splitting an inputted letter string data piece, the split letter string data serving as input data to be inputted into a machine-learning model that performs an inference process, training the word splitter based on biasedness of occurrence frequency in the plurality of classes for each of a first plurality of letter strings included in a plurality of pieces of the split letter string data, the plurality of pieces of the split letter string data being obtained by inputting the letter string data piece into the word splitter and by splitting the letter string data piece in respective different splitting patterns corresponding to the letter string data piece.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of variations in an inference result of a downstream model according to tokenizing patterns for tokenization;

FIG. 2 is a diagram illustrating an approach according to an embodiment;

FIG. 3 is a diagram illustrating a detailed example of an approach for adjusting a score;

FIG. 4 is a block diagram schematically illustrating an example of a hardware configuration of a computer that achieves the function of a server according to an example of the embodiment;

FIG. 5 is a block diagram schematically illustrating an example of a software configuration of the server according to an example of the embodiment;

FIG. 6 is a diagram illustrating an example of parameters;

FIG. 7 is a diagram illustrating an example of updated parameters;

FIG. 8 is a diagram illustrating an example of a training data set;

FIG. 9 is a diagram illustrating an example of training a tokenizer in a first approach;

FIG. 10 is a diagram illustrating an example of training a tokenizer in a second approach;

FIG. 11 is a diagram illustrating an example of a result of classification according to an approach for training the tokenizer;

FIG. 12 is a diagram illustrating an example of a result of classification according to an approach for training the tokenizer using a pseudo label;

FIG. 13 is a flow diagram illustrating an example of operation for a training process of a tokenizer performed by the server of the one embodiment in the first approach;

FIG. 14 is a flow diagram illustrating an example of operation for a training process of a tokenizer performed by the server of the embodiment in the second approach; and

FIG. 15 is a flow diagram illustrating an example of an operation for an inference process performed by the server of the embodiment.

### DESCRIPTION OF EMBODIMENT(S)

In the above-described approach, since the downstream model is assured which means that the type, the parameters, the architecture, and the like of the downstream model are assured, the tokenizer can be adjusted to optimally fit to the downstream model whereas the application scene of the above approach is limited to a circumstance where the downstream model is assured.

Hereinafter, an embodiment will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. Further, each of the drawings can include additional functions not illustrated therein to the elements illustrated in the drawing.

### (A) Explanation of Adjusting Tokenization

First, description will now be made in relation to adjustment of tokenization. The tokenizer (word splitter) tokenizes a text inputted therein and inputs multiple words (tokens) obtained as a result of the tokenization into the downstream model. A tokenizer is one of an example of a word splitter. A text is an example of letter string data piece. Further, multiple words (tokens) split from a text by a tokenizer is an example of split letter string data. Hereinafter, multiple words (tokens) may be referred to as a “tokenized text”. In addition, hereinafter, a “token” may be referred to as a “word.”

The downstream model is a trained machine learning model that executes various AI (Artificial Intelligence) tasks related to NLP. The downstream model may be, for example, a classifier (document classifier) that carries out classification (document classification) of a text to be inputted. The classification is a process of parsing a potential meaning of a text to be inputted and classifying the text into one of multiple classes. Examples of the classification are various classification tasks such as emotional classification and topical classification. The AI tasks executed by the downstream model are not limited to the classification, and may be various inference processes for outputting an inference result, using a text as input data.

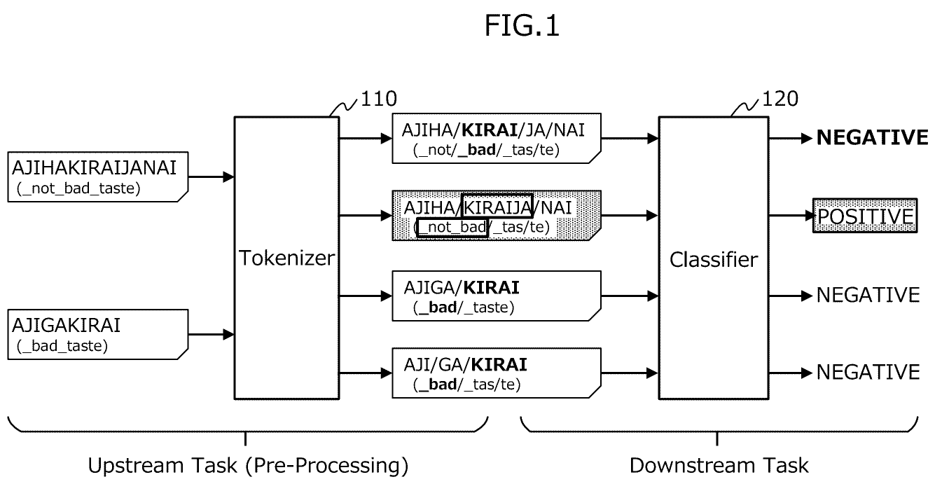

FIG. 1 is a diagram illustrating an example of variations in an inference result of a downstream model according to tokenizing patterns for tokenization. A tokenizer (word splitter) 110 tokenizes (splits), as an upstream task (pre-processing), each input text into multiple words (tokens) by means of tokenization.

FIG. 1 illustrates an example in which, if two texts of “AJIHAKIRAIJANAI” (_not_bad_taste) and “AJIGAKIRAI” (_bad_taste) are inputted into the tokenizer 110, the tokenizer 110 tokenizes each text in the following tokenizing patterns.

”AJIHA/KIRAI/JA/NAI”(_not/_bad/_tas/te)
”AJIHA/KIRAIJA/NAI”(_not_bad/_tas/te)
”AJIGA/KIRAI”(_bad/_taste)
”AJI/GA/KIRAI”(_bad/_tas/te)

Hereinafter, as the above tokenizing patterns, the delimiter in a text by means of tokenization is represented by a slash (/). This means that a letter string from the beginning of the text to the first slash, one or more letter strings between slashes, and a letter string from the last slash to the end of the sentence are words (tokens).

The approach according to the one embodiment is applicable to various languages. In the above example, a letter string in the parentheses appended to the text indicates an example of the meaning of the text expressed in a second language (English in the example of FIG. 1) different from the first language (Japanese in the example of FIG. 1) of the text for convenience. In the expression in the second language, the underscore “_” indicates a half-width space as one letter. In addition, a letter string in the parentheses appended to each of the multiple words (tokens) indicates meaning of a token obtained by tokenization in a second language (English in the example of FIG. 1) different from the first language (Japanese in the example of FIG. 1) of the text for convenience.

For example, as in a case where one word is split into multiple subwords, the tokens do not necessarily have to be units each having meaning. Furthermore, since the first language and the second language may have a difference in the language structure such as the presence or absence of “a space between words”, the words in the same delimiting position (for example, “AJIHA” and “_not”) between the first and second languages do not always correspond to each other. That is, the text and the word in the first language may be regarded as ones independent from the text and the word in the second language denoted in the parentheses.

A classifier (document classifier) 120 is an example of the downstream model that performs the downstream process. The classifier 120 according to the one embodiment classifies a tokenized text obtained through the tokenization on each text by the tokenizer 110 as input data into one of multiple classes. For example, the classifier 120 performs emotional classification as an example of the classification. The emotional classification is a task of analyzing the potential meaning of each inputted tokenized text and classifying the tokenized text into one of multiple classes related to an emotion of “POSITIVE” and “NEGATIVE”. The following description assumes that the number of classes is two, but the number of classes may be three of more.

In the example of FIG. 1, the appropriate class for the text “AJIHAKIRAIJANAI” (_not_bad_taste) is “POSITIVE”. For example, the classifier 120 classifies the tokenized text “AJIHA/KIRAIJA/NAI” (_not_bad/_tas/te) into POSITIVE under the influence of the word “KIRAIJA” (_not_bad) indicated by a square frame. On the other hand, the classifier 120 may classify the tokenized text “AJIHA/KIRAI/JA/NAI” (_not/_bad/_tas/te) into “NEGATIVE” under the influence of the bold word “KIRAI” (_bad).

As the above, respective different tokenizing patterns for the same text may lead to different results of emotional classification (i.e., different inference result). To avoid this situation, it is important to appropriately tokenize (word-split) a text such that the performance of the downstream task is enhanced, which is exemplified by tokenization that makes it possible to correctly predict the class in the classification.

For example, the above tokenizer can be adjusted to be optimally fit to the downstream model by adopting an approach which simultaneously optimizes (adjusts) the tokenization and the downstream model by activating the tokenizer and the downstream model in parallel. However, since the application scene of this approach is limited to a circumstance where the downstream model is assured, the versatility of the tokenizer may be reduced. As the above, the enhancement in inference quality of the downstream model and the versatility of the tokenizer are in a trade-off relationship.

As one aspect, description of the one embodiment will now be made in relation to an approach that can appropriately adjust a tokenizer (word splitter) that inputs data into a machine learning model regardless of the machine learning model. For example, the approach of one embodiment can achieve the training of the tokenizer that can contribute to enhancement in performance of the downstream model in an application scene under a circumstance where the downstream model is not assured. An example of an application scene under a circumstance where the downstream model is not assured is a situation where the combination of a text and a class to be used in the downstream task is already provided but the downstream model, parameters of the downstream model, an architecture of the classification are not assured yet. As another aspect, description of the one embodiment will now be made in relation to the approach that can keep the performance in inference quality of the downstream model above the trade-off level while the versatility of the tokenizer is enhanced.

### (B) Description of Method According to the One Embodiment

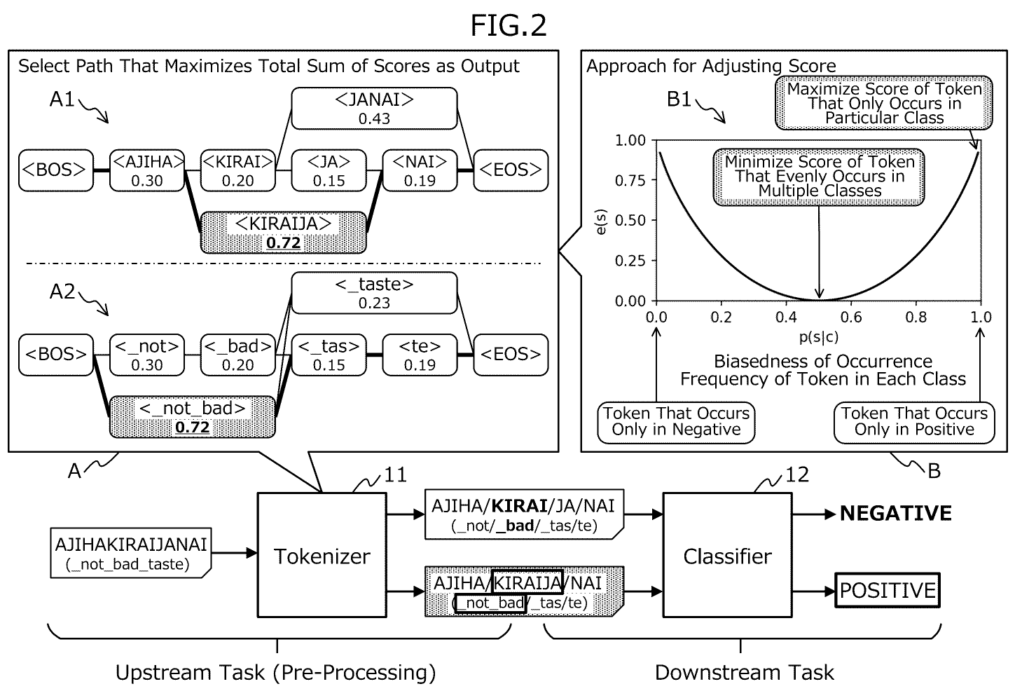

FIG. 2 is a diagram for describing an approach according to one embodiment. A tokenizer 11 is an example of a word splitter that outputs, as an upstream task, tokenized letter string data (split letter string data) including multiple letter strings generated by splitting (tokenizing) an inputted letter string data piece. The classifier (document classifier) 12 is an example of a downstream model (machine learning model) that performs, as a downstream task, inference process using the tokenized letter string data outputted from the tokenizer 11. That is, the tokenized letter string data outputted from the tokenizer 11 becomes an input data to be inputted into the classifier 12. The tokenizer 11 and the classifier 12 may be the same as the tokenizer 110 and the classifier 120 shown in FIG. 1, respectively, except for points to be described below.

Description will now be made in relation to an example of an approach for outputting a tokenized text by the tokenizer 11 that executes the upstream task with reference to the reference symbol A. In the reference symbol A (reference symbols A1 and A2), multiple words (tokens) obtained by tokenizing (splitting) a text in multiple tokenizing patterns are enclosed in rounded square frames. In each rounded square frame, a word obtained by tokenizing is placed in angle brackets and the score (token score) of the word is attached below the word. The expression <BOS (Beginning of Sentence)> represents the beginning of the text, and the expression <EOS (End of Sentence)> represents the end of the text. A path from the beginning of the sentence to the end of the sentence through solid lines connecting two adjacent round square frames is a “path”, which is an example of a tokenizing pattern.

As shown in the reference symbols A1 and A2, the tokenizer 11 selects, as an output, a path that maximizes the sum of the scores of the multiple words (tokens) obtained by tokenizing the text.

In the example of the reference symbol A1, the tokenizer 11 selects, from the following result, a tokenizing pattern of “AJIHA/KIRAIJA/NAI” having the maximum total score (1.21) as the tokenized text of the text of “AJIHAKIRAIJANAI”.
“AJIHA/KIRAI/JANAI”: 0.30+0.20+0.43=0.93.
“AJIHA/KIRAI/JA/NAI”: 0.30+0.20+0.15+0.19=0.84
“AJIHA/KIRAIJA/NAI”: 0.30+0.72+0.19=1.21

In the example of the reference symbol A2, the tokenizer 11 selects, from the following result, a tokenizing pattern of “_not_bad/_tas/te” having a maximum total score (1.06) as the tokenized text of the text of “_not_bad_taste”.
“_not/_bad/_taste”: 0.30+0.20+0.43=0.93
“_not/_bad/_tas/te”: 0.30+0.20+0.15+0.19=0.84
“_not_bad/_taste”: 0.72+0.23=0.95
“_not_bad/_tas/te”: 0.72+0.15+0.19=1.06

A combination between a word and a score of the word is held as a parameter in the tokenizer 11 and is referred to for selecting a tokenizing pattern when the tokenization (word splitting) is performed.

The one embodiment causes the tokenizer 11 to output an appropriate tokenized text by adjusting the scores of the words such that the tokenizer 11 is caused to carry out tokenization in a particular tokenization pattern. An example of the appropriate tokenized text is data that, for example, when being inputted as input data to the downstream model, allows the downstream task by the downstream model to obtain an appropriate inference result. In the example of FIG. 2, the appropriate tokenized text is a tokenized text that emotionally classifies the text “AJIHAKIRAIJANAI” or “_not_bad_taste” into the appropriate class (e.g., POSITIVE), and is specifically multiple words including, for example, “KIRAIJA” or “_not_bad” indicated by a hatched rounded square frame. That is, as shown in the reference symbol A1 and A2, the one embodiment adjusts the scores such that the tokenizer 11 outputs the paths indicated by the thick solid lines.

Next, description will now be made in relation to an approach of adjusting the score of the one embodiment with reference to the reference symbol B. The approach of adjusting according to the one embodiment adjusts the score of each of the words included in tokenized texts on the basis of biasedness of occurrence frequency in the multiple classes for each word included in tokenized texts.

The graph B1 is an example of a score indicating a biasedness of the occurrence frequency (degree of occurrence) of a class for each word (token). The vertical axis of the graph B1 indicates the score e(s) of the token, and the horizontal axis indicates the biasedness p (s| c) of the occurrence frequency of the token for each class. Here, the term V(S) represents a set of candidates S′ for tokenization of a certain text S that can be generated from the vocabulary V consisting of |V|. The symbol s is one of the |S′| tokens constituting the candidates S′ for tokenization, and the set S′ is represented by S′=<s₁, s₂, . . . s_{|s′|}>. The symbol “c” is one of the classes, such as POSITIVE and NEGATIVE.

The reference symbol B represents a graph of a two-dimensional space having a class number of two. If the class number is three or more, a graph B1 of the three-dimensional space including the horizontal axis for each combination of two of the classes may be generated, and the score e(s) of the token may be obtained on the basis of the graph B1.

The symbol e(s) represents a score of a token s according to p (s|c). The term p (s| c) indicates a probability that the token s is included (occurs) in the text of the class c (for example, a probability that “KIRAIJA” is included in a text of which the class is POSITIVE). For example, p (s| c)=0.5 means that the token s occurs equally in multiple classes c, and p (s|c)=0.0 or 1.0 means that the token s occurs only in a particular class c. In the example of FIG. 2, the score of a token s that occurs only in texts of POSITIVE is p (s| c=“POSITIVE”)≈1.0, and the score of a token s that occurs only in texts of NEGATIVE is p(s|c=“NEGATIVE”)=0.0.

The graph B1 is represented by a function that minimizes the score e(s) of a token s that occurs equally in the multiple classes c, and maximizes the score e(s) of a token s that occurs only in a particular class among the multiple classes c.

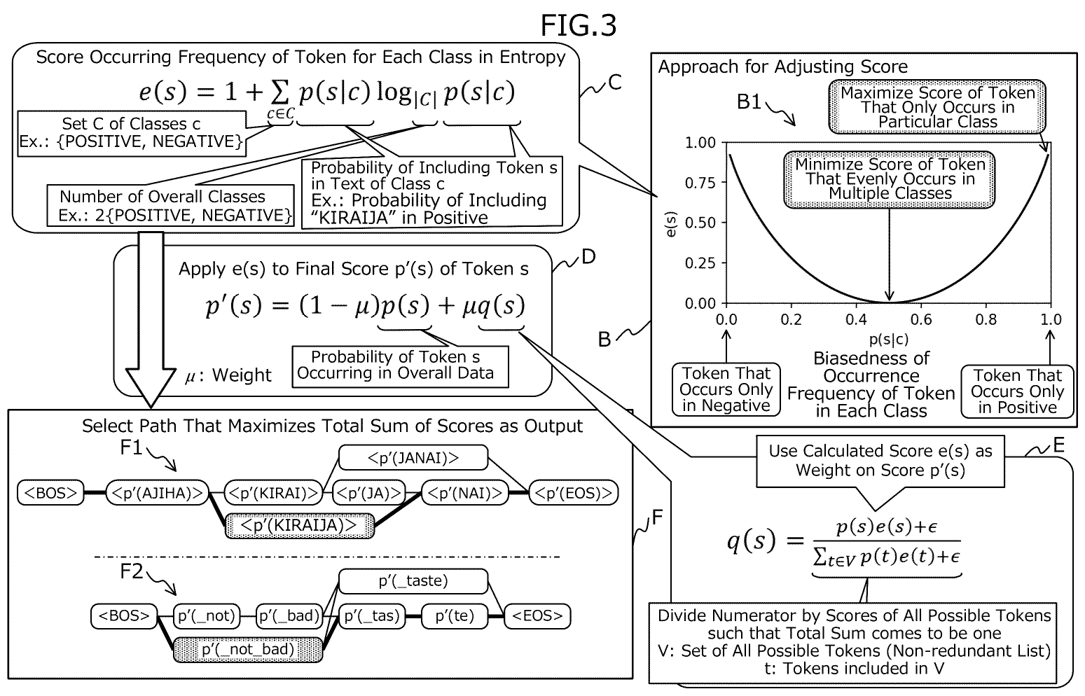

FIG. 3 is a diagram for explaining a detailed example of an approach for adjusting the score. As indicated by the reference symbol C, the score e(s) is calculated (scored) by setting the occurrence frequency for each class c of the token s in entropy, for example, according to the following Equation (1).

$$e ( s ) = 1 + {\sum }_{c ∈ C} p ( s \vert c ) {log}_{\vert C \vert} p ( s \vert c ) \qquad ( 1 )$$

In the above Equation (1), CEC is a set C of classes c, and is exemplified by {POSITIVE, NEGATIVE}. The term|C| represents the total number of classes included in the set C, and is two (POSITIVE, NEGATIVE), for example.

As indicated by reference symbol D, the score e(s) calculated by the above-described approach is applied to the final score p′ (s) of the token s. The final score p′ (s) is calculated, for example, according to the following Equation (2).

$${p}^{′} ( s ) = ( 1 - μ ) p ( s ) + μ q ( s ) \qquad ( 2 )$$

In the above Equation (2), the symbol p(s) represents the probability that the token s occurs in the entire data, and is an example of the final score of each token s to be used in the tokenizer 110 (see FIG. 1). The symbol u represents a predetermined weight. The term q(s) represents a function for applying, as a weight, information of the occurrence frequency for each class c of the token s to the final score p′ (s) on the basis of the above score e(s), and is calculated, for example, according to the following Equation (3).

$$q ( s ) = \frac{p ( s ) e ( s ) + ϵ}{{\sum }_{t ∈ V} p ( t ) e ( t ) + ϵ} \qquad ( 3 )$$

In the above Equation (3), the symbol & represents a minute value for preventing the probability of the token s from becoming zero. The symbol V represents a set (list not containing redundancy) of all possible tokens (vocabulary) and the symbol t is the token t contained in the set (vocabulary) V. The symbol Σ on the denominator on the right side means that the numerator is divided by scores of all possible tokens such that total sum comes to be one.

As indicated by the reference symbol F (F1 and F2), the final score p′(s) is used to determine the path to be selected as the output in the tokenizer 11.

As described above, the approach of the one embodiment adjusts the parameters of the tokenizer 11 such that a token s having a larger biasedness in occurrence frequency in the multiple classes are set to have a higher score. Then, for each of multiple inputted texts, the tokenizer 11 outputs, based on the parameters, a tokenized text having the maximum total scores of multiple words among the multiple tokenized texts obtained by inputting the text into the tokenizer 11. Accordingly, training the tokenizer 11 on the basis of the class information can optimize the tokenizer 11 such that the classifier 12 can execute appropriate classification.

As described above, the one embodiment carries out tokenization considering information about the class ceC used in the classification by the classifier 12. That is, in order to achieve the tokenization considering the class information, the one embodiment replaces the score p(s), which is the probability of the token used by the tokenizer 110, by a weighted sum (the score p′ (s)) obtained by using the score p(s), q(s) (e(s)) including information about the class ceC, and the weight μ, as indicated by the above Equation (2).

### (C) Example of Configuration of Server

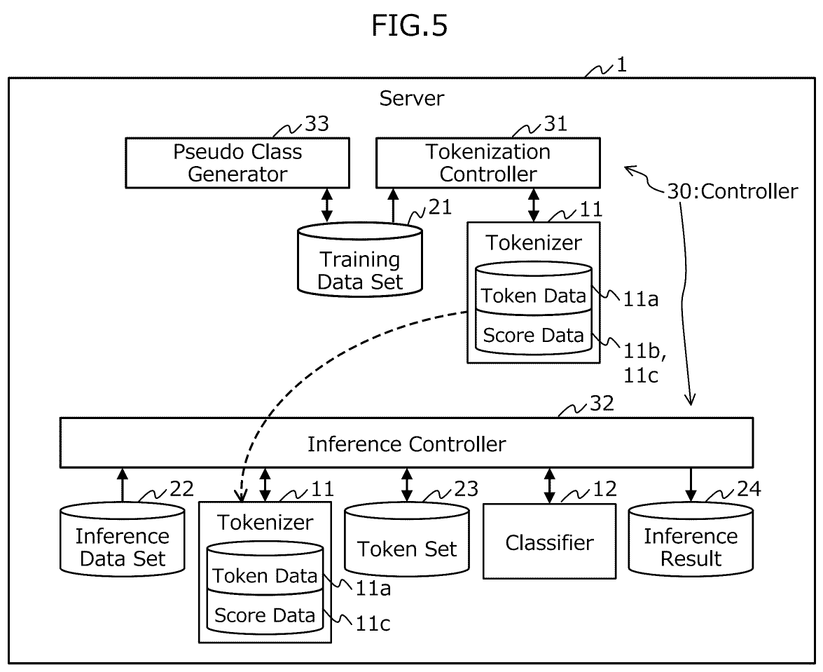

Next, description will now be made in relation to an example of the configuration of the server 1 (see FIG. 5) that achieves the approach according to the above embodiment.

### (C-1) Example of Hardware Configuration

The server 1 according to the one embodiment may be a variety of servers, for example, a virtual server (VM; Virtual Machine) or a physical server. The function of the generating device 1 may be achieved by one computer or by two or more computers. Further, at least a part of the functions of the server 1 may be implemented using Hardware (HW) resources and Network (NW) resources provided by cloud environment.

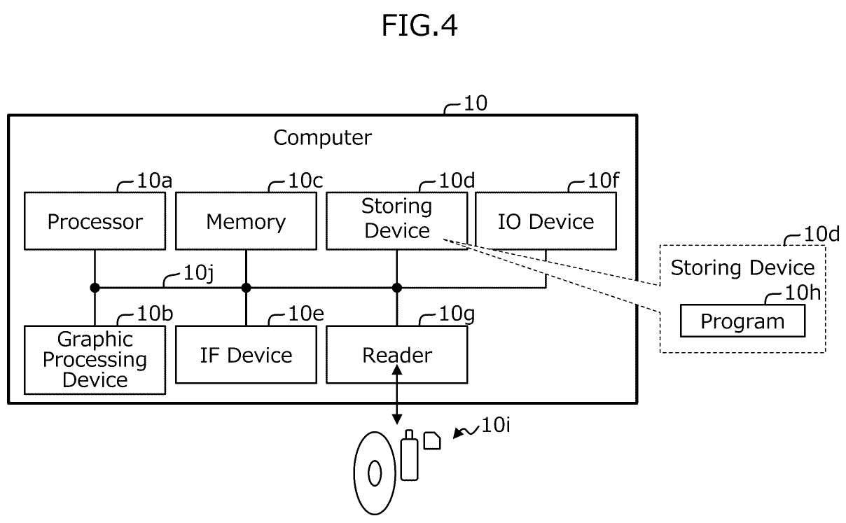

FIG. 4 is a block diagram illustrating an example of a hardware (HW) configuration of a computer 10 that achieves the function of a generation device 1 according to an embodiment. If multiple computers are used as the HW resources for achieving the functions of the generating device 1, each of the computers may include the HW configuration illustrated in FIG. 4.

As illustrated in FIG. 4, the computer 10 may illustratively include, as the HW configuration, a processor 10a, a graphic processing device 10b, a memory 10c, a storing device 10d, an Interface (IF) device 10e, an Input/Output (IO) device 10f, and a reader 10g.

The processor 10a is an example of an arithmetic processing device that performs various types of control and calculations. The processor 10a may be mutually communicably connected to each of the blocks in the computer 10 via a bus 10j. The processor 10a may be a multi-processor including multiple processors or a multi-core processor including multiple processor cores, or may have a structure including multi-core processors.

The processor 10a may be any one of integrated circuits (ICs) such as CPUs (Central Processing Units), MPUs (Micro Processing Units), APUS (Accelerated Processing Units), DSPs (Digital Signal Processors), ASICs (Application Specific Integrated Circuits), and FPGAS (Field Programmable Gate Arrays), or combinations of two or more of these ICs.

The graphic processing device 10b carries out screen display control on an outputting device such as a monitor of the IO device 10f. In addition, the graphic processing device 10b may have a configuration as an accelerator that executes a machine learning process and an inference process using a machine learning model. Examples of the graphic processing device 10b are various arithmetic processing devices of integrated circuits (ICs) such as GPUS (Graphics Processing Unit), APUs, DSPs, ASICs, or FPGAs.

The memory 10c stores various pieces of data and information of a program, for example. An example of the memory 10 c is one of a volatile memory such as a Dynamic Random Access Memory (DRAM) and a non-volatile memory such as a persistent Memory (PM) or the both.

The storing device 10d stores information such as various data, programs, and the likes. Examples of the storing device 10d may be various storing devices including a magnetic disk device such as a Hard Disk Drive (HDD), a semiconductor drive device such as a Solid State Drive (SSD), a nonvolatile memory, and the like. The non-volatile memory may be, for example, a flash memory, a Storage Class Memory (SCM), a Read Only Memory (ROM), and the like.

The storing device 10d may store a program 10h (information processing program) that implements all or a part of various functions of the computer 10. For example, the processor 10a of the server 1 can achieve the function of a controller 30 (see FIG. 5) mentioned below by expanding the program 10h stored in the storing device 10d on the memory 10c and executing the expanded program 10h.

The IF device 10e is an example of a communication IF that controls connection and communication between the server 1 and another computer. For example, the IF device 10e may include an applying adapter conforming to Local Area Network (LAN) such as Ethernet (registered trademark) or optical communication such as Fibre Channel (FC). The applying adapter may be compatible with one or both of wireless and wired communication schemes. Furthermore, the program 10h may be downloaded from the network to the computer 10 through the communication IF and be stored in the storing device 10d.

The IO device 10f may include one or both of an input device and an output device. Examples of the input device include a keyboard, a mouse, and a touch panel. Examples of the output device include a monitor, a projector, and a printer. The IO device 10f may include, for example, a touch panel that integrates an input device and an output device with each other. The output device may be connected to the graphic processing device 10b.

The reader 10g is an example of a reader that reads information of data and programs recorded on a recording medium 10i. The reader 10g may include a connecting terminal or device to which the recording medium 10i can be connected or inserted. Examples of the reader 10g include an applying adapter conforming to, for example, Universal Serial Bus (USB), a drive apparatus that accesses a recording disk, and a card reader that accesses a flash memory such as an SD card. The program 10h may be stored in the recording medium 10i. The reader 10g may read the program 10h from the recording medium 10i and store the program 10h into the storing device 10d.

Examples of the recording medium 10i illustratively include a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is illustrative. Accordingly, the computer 10 may appropriately undergo increase or decrease of HW devices (e.g., addition or deletion of arbitrary blocks), division, integration in an arbitrary combination, or addition or deletion of the bus.

### (C-2) Example of Software Configuration

FIG. 5 is a block diagram illustrating an example of a software configuration of the server 1 according to an example of the one modification. The server 1 is an example of a computer or an information processing device that trains the tokenizer 11 by adjusting the scores.

As shown in FIG. 5, the server 1 may illustratively include the tokenizer 11, the classifier 12, a tokenization controller 31, and an inference controller 32. The server 1 may further include a pseudo-class generator 33. The elements 31 to 33 included in the server 1 are an example of the controller 30. The function of the controller 30 may be achieved by, for example, the processor 10a of the computer 10 illustrated in FIG. 4 executing the program 10h expanded on the memory 10c.

Also, as illustrated in FIG. 5, the server 1 may illustratively include a storing region capable of storing word information 11a, score information 11b and 11c, a training data set 21, an inference data set 22, a token set 23, and an inference result 24. In addition to the above, the server 1 may include a storing region capable of storing data of the tokenizer 11 and the classifier 12, such as model data of a neural network.

The storing region that the server 1 may be achieved by one of the storing regions of the memory 10c and the storing device 10d of the computer 10 illustrated in FIG. 4 or the both.

The server 1 (controller 30) may, for example, receive at least one of the training data set 21 and the inference data set 22 from another computer (not illustrated) via the IF device 10e and a network and store the received data set in the storing region.

Further, the server 1 (controller 30) may transmit at least one of the tokenizer 11, the score information 11c, and an inference result 24 stored in the storing region to another computer (not illustrated) via the IF device 10e and a network, for example. Further, the server 1 may transmit at least one of the intermediate data, such as the tokenizer 11, the word information 11a, the score information 11b, and the token set 23, which are being used in the middle of the training process, to another computer (not illustrated) via the IF device 10e and a network.

If the server 1 transmits one of the tokenizer 11 and the score information 11b or the both to a non-illustrated another computer, the functions of the classifier 12 and the inference controller 32 may be included in the other computer instead of the server 1. In this case, the data of the classifier 12, the inference data set 22, the token set 23, and the inference result 24 may be stored in the storing region included in the other computer instead of a storing region included in the server 1.

The tokenizer 11 is an example of the tokenizer 11 illustrated in FIG. 2. The tokenizer 11 may be, for example, one that employs an approach using a unigram-language model. For example, the tokenizer 11 may perform tokenization based on a vocabulary and scores included in the word information 11a and the score information 11b or 11c by referring to the word information 11a indicating vocabulary that the tokenizer 11 can handle, i.e., tokens, and the score information 11b or 11c that stores scores associated with the vocabulary. The word information 11a, the score information 11b and 11c are examples of parameters of the tokenizer 11.

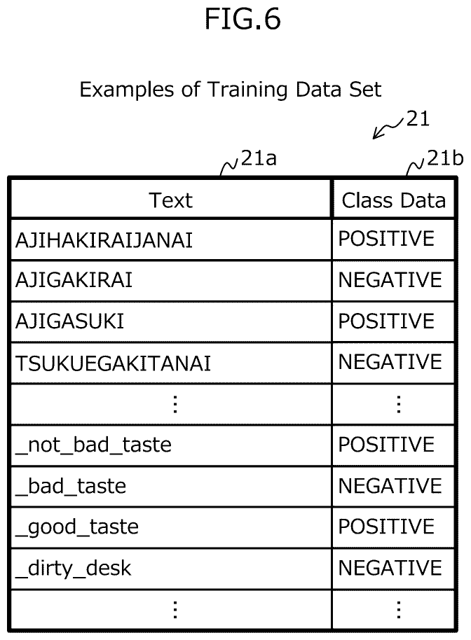

FIG. 6 is a diagram illustrating an example of the parameters. FIG. 6 illustrates an example of the word information 11a which is a list of words (tokens) such as “AJIHA” and “_taste” and the score information 11b which has not been updated by the tokenization controller 31. The score information 11b includes a score p(s) calculated for each word in the word information 11a.

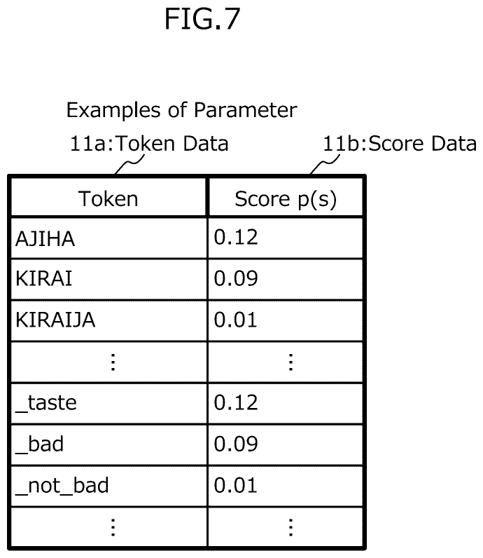

FIG. 7 is a diagram illustrating an example of updated parameters. FIG. 7 illustrates an example of the word information 11a and the score information 11c updated from the score information 11b by the tokenization controller 31. The score information 11c includes a score p(s) the same as that in FIG. 6, and a score p′ (s) (see the above Equation (2)) calculated on the basis of the information on the classes. The score information 11c may include a score p′ (s) without including the score p(s), and may include a score q(s) (see the above Equation (3)) instead of the score p′ (s).

The tokenization controller 31 trains the tokenizer 11 using the training data set 21. For example, in training the tokenizer 11 using the training data set 21, the tokenization controller 31 trains the tokenizer 11 based on the biasedness of the occurrence frequency in the multiple classes for each of the words (tokens, letter strings) included in the multiple tokenized texts obtained by inputting the text 21a into the tokenizer 11 and by tokenizing the text 21a in respective different tokenizing patterns corresponding to the text 21a. For example, the tokenization controller 31 trains the tokenizer 11 on the basis of the biasedness of the occurrence frequency in the multiple classes for each word (letter string) included in the multiple words (tokenized text) for each of the multiple tokenized texts.

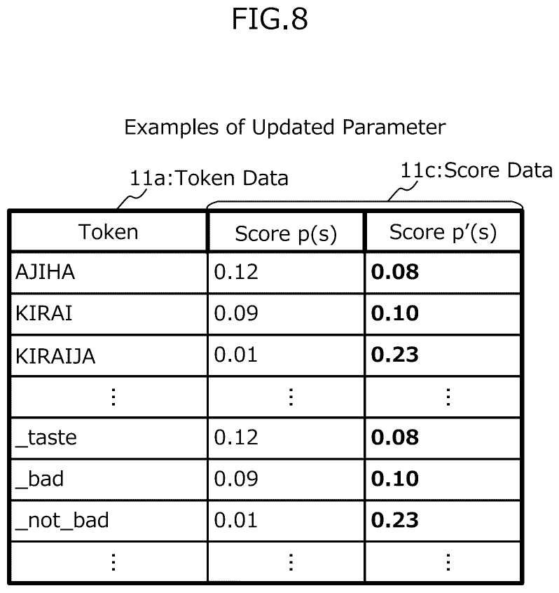

FIG. 8 is a diagram illustrating an example of the training data set 21. As illustrated in FIG. 8, the training data set 21 may illustratively include, for example, multiple training data pieces each in which a text 21a serving as an example of letter string data is associated with the class information 21b indicating which class c of the multiple classes (set C) the text 21a pertains to. The training data may include, for example, a combination of a text and a class to be used in an inference process by the classifier 12.

Training of the tokenizer 11 by the tokenization controller 31 may be implemented by the following first or second approach, depending on whether the machine learning (i.e., the training) of the tokenizer 11 has completed.

### (First Method)

The first approach is an approach of applying a score q(s) to the tokenizer 11 that has already completed machine learning (trained). In the first approach, the training of the tokenizer 11 may include a process of updating (adjusting) the score information 11b or 11c for multiple words in parameters of the tokenizer 11. In this case, in the training of the tokenizer 11, the machine relearning (re-training) of the tokenizer 11 may be omitted.

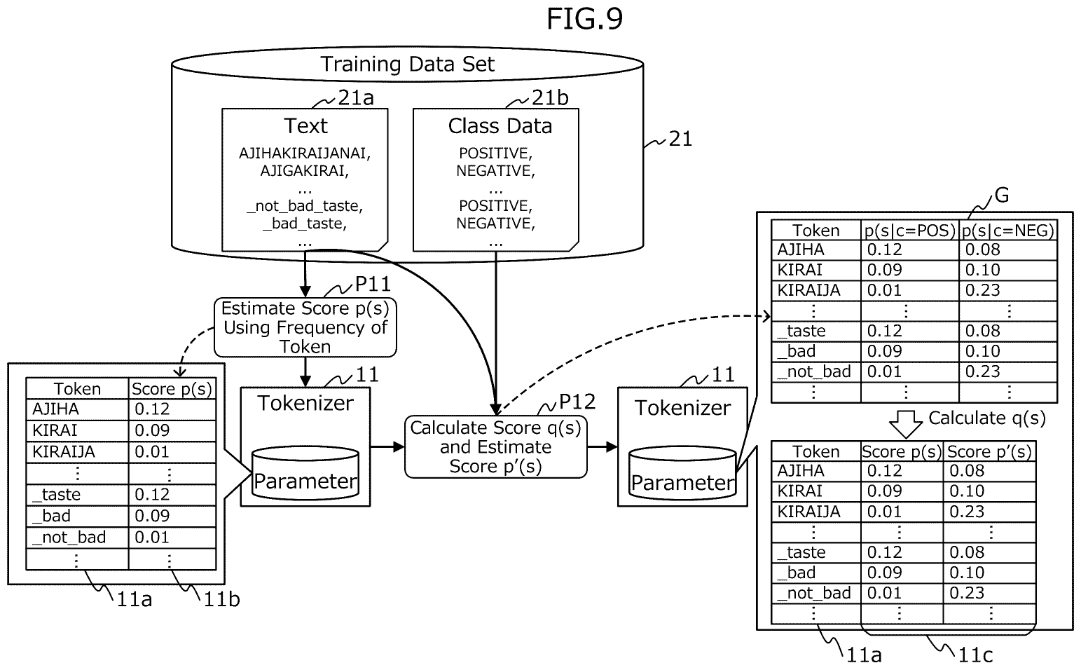

FIG. 9 is a diagram for describing an example of the training of the tokenizer 11 according to the first approach. In FIG. 9, description will now be made in relation to, in sequence, a machine-learning phase on the tokenizer 11 and the updating phase of the scores (the training process of the tokenizer 11 by the tokenization controller 31).

As illustrated in FIG. 9, in the machine-learning phase of the tokenizer 11, the tokenizer 11 splits (tokenizes) each of the texts 21a included in the training data set 21 into multiple words (tokens) based on the word information 11a (the process is sometimes referred to as tokenization). In the process P11, the tokenization controller 31 estimates the score p(s) of each of the multiple words obtained by tokenization 11 by using the occurrence frequency of the word, and stores the score p(s) in the score information 11b in association with the word.

As an example, in the process of tokenization using a unigram-language model by the tokenizer 11, the tokenizer 11 may calculate the candidate S′\hat{ } for the tokenization that maximizes the probability p (S′ |S) of the tokenization via, for example, the Viterbi algorithm. For example, the candidate S′\hat{ } and the probability p (S′ |S) of the tokenization may be calculated according to the following Equations (4) and (5), respectively.

$$\hat{{S}^{′}} = {arg max}_{{S}^{′} ∈ V ( S )} p ( {S}^{′} \vert S ) \qquad ( 4 )$$

$$p ( {S}^{′} \vert S ) = {\prod }_{s ∈ {S}^{′}} p ( s ) \qquad ( 5 )$$

In Equation (5), the machine learning using an EM (Expectation Maximization) algorithm may be used to estimate the probability p(s) of the unigram. The Viterbi algorithm and the EM algorithm are machine learning approaches of the tokenizer 11, and are unsupervised learning approaches for estimating p(s) and p (s|c).

The server 1 may omit the execution of the process of the machine-learning phase of the tokenizer 11. For example, the server 1 may obtain the machine-learned tokenizer 11 that completes machine learning and the parameters (word information 11a and the scoring information 11b) from another computer.

As shown in FIG. 9, in the updating phase of the score, the tokenization controller 31 calculates a probability p (s|c) for every possible token s based on the score information 11b and the multiple training data piece (texts 21a and class information 21b) included in the training data set 21. The reference symbol G indicates an example of the occurrence probability p (s|c) of a word (token) for each class. As indicated by the reference symbol G, the probability p (s| c=POS) that a word occurs in the class of POSITIVE and a probability p (s| c=NEG) that the word occurs in the class of NEGATIVE are calculated for each word and each class.

The tokenization controller 31 calculates the score e(s) based on the probability p (s|c) according to the above Equation (1), and calculates the score q(s) based on the score e(s) according to the above Equation (3). Then, the tokenization controller 31 estimates the score p′ (s) based on the score p(s) and the score q(s) according to the above Equation (2), and stores the estimated score p′ (s) in the score data 11c in association with the corresponding word. Accordingly, the tokenizer 11 can perform tokenization based on the updated parameters (score-information 11c) in the pre-processing of the inference process by the document classifier 12.

### (Second Method)

The second approach is an approach of generating the tokenizer 11 while considering the score q(s), and is an approach of applying the score p(s) to the machine learning process of the tokenizer 11. In the second approach, the training of the tokenizer 11 may include a machine learning process of the tokenizer 11 and a process of updating (adjusting) the score information 11b or 11c for multiple words in parameters of the tokenizer 11 in the machine learning process.

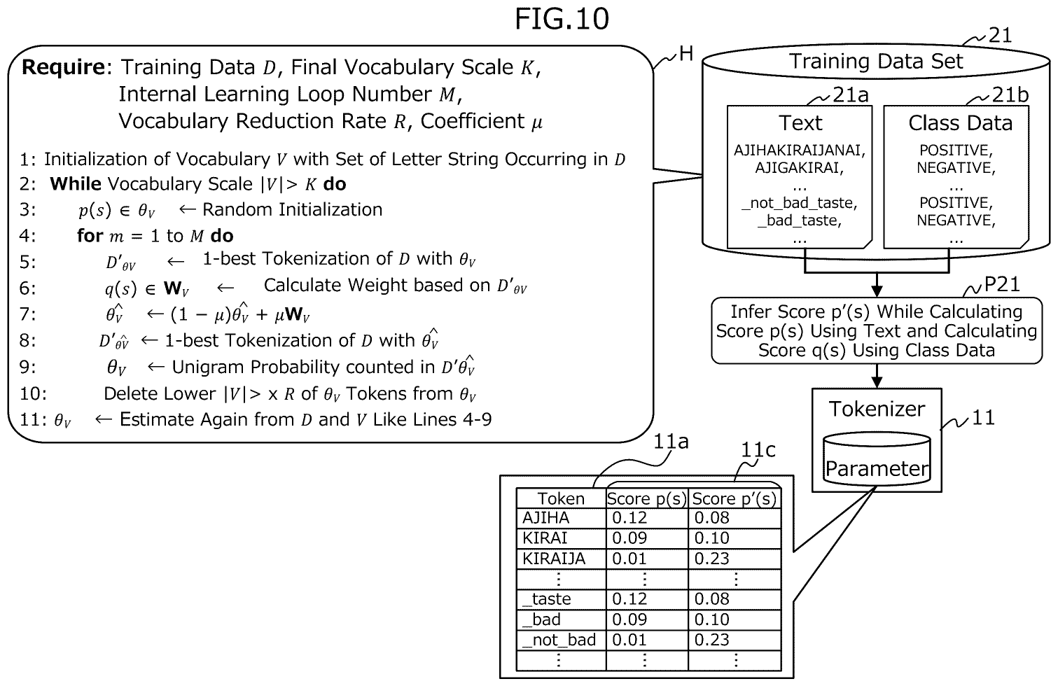

FIG. 10 is a diagram for describing an example of the training of the tokenizer 11 according to the second approach. As illustrated in FIG. 10, in Process P21, the tokenization controller 31 estimates the score p(s) of a word obtained by inputting the text 21a included in the training data set 21 into the tokenizer 11 and tokenizing the inputted text 21a by the tokenizer 11, using the occurrence frequency of the word.

Further, the tokenization controller 31 calculates a probability p (s|c) for every possible token s on the basis of the estimated score p(s) and multiple training data pieces (text 21a and class information 21b) included in the training data set 21. Furthermore, in Process P21, the tokenization controller 31 calculates the score e(s) based on the probability p (s|c) according to the above Equation (1), and calculates the score q(s) based on the score e(s) according to the above Equation (3).

Then, in Process P21, the tokenization controller 31 estimates the score p′ (s) based on the score p(s) and the score q(s) according to the above Equation (2), and stores the estimated score p′ (s) in the score data 11c in association with the word. Accordingly, the tokenizer 11 can perform tokenization based on the updated parameters (score information 11c) in the pre-processing of the inference process by the classifier 12.

An example of an algorithm for training the tokenizer 11 according to the second approach is indicated by the reference symbol H. The reference symbol H illustrates an example of an algorithm when the second approach is applied to machine learning using the Viterbi algorithm. In the symbol H, training data D of Require (precondition) is an example of training data including the text 21a and the class information 21b.

In the first line of the reference symbol H, the vocabulary V is initialized by a set of letter strings occurring in the training data D. A process of the second to eleventh lines is repeated as long as a condition that the vocabulary scale |V| is greater than K is satisfied. In the third line, the score p(s) corresponding to each token s included in the vocabulary V is randomly initialized. The scores p(s) corresponding to all the tokens s included in the vocabulary V are collectively denoted by a score Ov. A process in the forth to tenth lines is repeated while the variable m is 1 to M.

The process in the fifth to ninth lines is an example of Process P21. In the fifth line, by employing an approach such as N-best tokenization (for example, N=1), the training data D is tokenized in N (for example, one) tokenizing patterns using the score θᵥ and consequently D′ₑᵥ is obtained. The value θᵥ obtained at this time is an example of the score p(s) calculated in Process P21.

In the sixth line, the weight Wᵥ of the vocabulary V is calculated on the basis of D′ₑᵥ obtained in the fifth line and the class information 21b of the vocabulary V. The weight Wᵥ is configured with the scores q(s) of all the tokens s included in the vocabulary V. The weight Wᵥ may be expressed by, for example, the right side of the above Expression (3).

In the seventh line, the score θᵥ \hat{ } is calculated as a weighted sum based on the score θᵥ, the weight Wᵥ obtained in the sixth line, and the coefficient μ. The value θᵥ\hat{ } obtained at this time is an example of the score p′ (s) estimated in Process P21.

In the eighth line, by employing an approach such as N-best tokenization (for example, N=1), the training data D is tokenized in N (for example, one) tokenizing patterns using the score θᵥ\hat{ } obtained in the seventh line and consequently D′_{ev\hat{ }} is obtained.

In the ninth row, θᵥ is updated with the unigram probability counted by θᵥ\hat{ }. The tenth line is a process of pruning the vocabulary V in accordance with the estimated scores p′ (s). In the tenth line, for example, the lower |V|*R tokens of the θᵥ are deleted from the V. In the eleventh line, θᵥ is estimated again on the basis of D and V in the same manner as in the fourth and ninth lines.

As described above, the tokenization controller 31 trains the tokenizer 11 by applying the scores q(s) based on the occurrence frequency of the respective words for each class to the score information 11c using a given text 21a and class information 21b, regardless of whether the tokenizer 11 has already completed machine-learning or not.

The above-described process by the tokenization controller 31 can also be regarded as part of a parameter updating process in the tokenizer 11 (machine learning model), which is executed in the course of the process of the tokenization by the tokenizer 11. Accordingly, at least a part of the functions of the tokenization controller 31 may be included in the tokenizer 11.

Returning to the explanation of FIG. 5, the pseudo-class generator 33 generates class information 21b as a pre-process of the training of the tokenizer 11 to be carried out by the tokenization controller 31.

The pseudo-class generator 33 generates a pseudo class of each of the text 21a, for example, on the basis of the text 21a included in training data set 21. The pseudo-class generator 33 stores the generated pseudo class as the class data 21b in the training data set 21 in association with the text 21a. An example of the approach of generating the pseudo-class may be any known approach, such as k-means clustering.

Even if the provided training data set 21 does not include the class information 21b, for example, the pseudo-class generator 33 can generate the pseudo class of each of the text 21a.

Therefore, for example, the server 1 is highly versatile because the approach of the one embodiment can be applied to an existing tokenizer trained on the basis of texts by obtaining the existing tokenizer and the texts. For example, since the server 1 can omit execution of a process of preparing a new training data set 21 and generating a new tokenizer 11, the processing time that the server 1 takes, a processing resources to be used, and the cost can be reduced.

The inference controller 32 controls the execution of an inference process using the tokenizer 11 and the classifier 12. For example, the inference controller 32 obtains the token set 23 including a tokenized text for each text by inputting the inference data set 22 into the tokenizer 11. The inference data set 22 may include multiple pieces of inference data, e.g., multiple texts. The token set 23 may include, for each of the multiple texts, multiple words (tokens) that are the results of the tokenization based on the word information 11a and the score information 11c.

The inference controller 32 executes an inference process by the classifier 12 using the multiple tokenized texts included in the token set 23 as the input data, and obtains the inference result 24 that is the result of classification of the tokenized texts (texts).

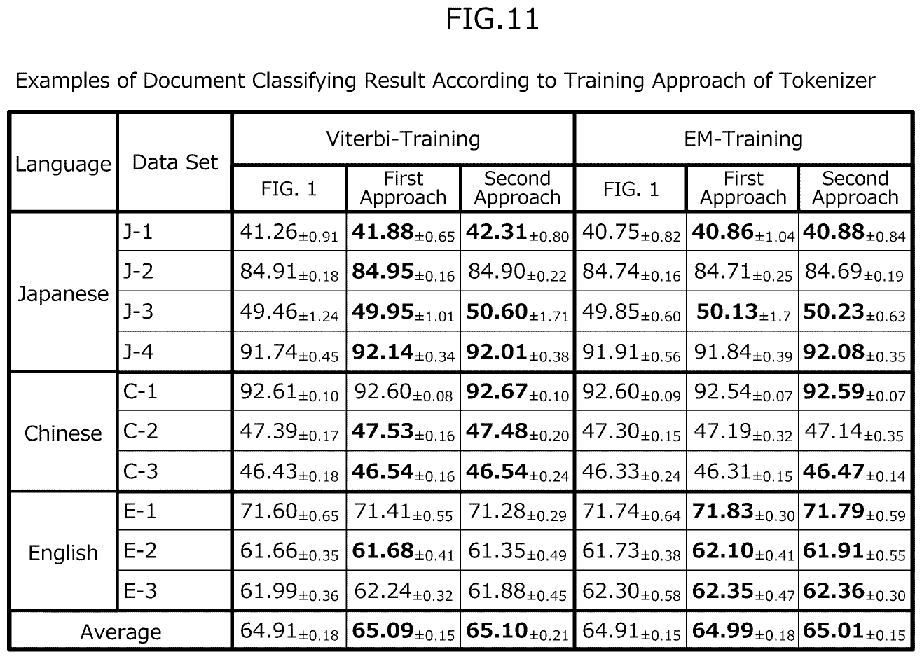

FIG. 11 is a diagram illustrating an example of a results of classification according to the training approach of the tokenizer 110 or 11. FIG. 11 illustrates an example of the results of classification that the classifier 12 executed using the tokenizer 110 (denoted as “FIG. 1”) illustrated in FIG. 1, the tokenizer 11 (denoted as “first approach”) trained by the first approach of FIG. 9, and the tokenizer 11 (denoted as “second approach”) trained by the second approach of FIG. 10. The classifier 12 executed the classification on data sets in three languages of Japanese, Chinese, and English, and the used data sets are the Japanese data sets represented by J-1 to J-4, the Chinese data sets represented by C-1 to C-3, and the English data sets represented by E-1 to E-3. The class information 21b is included in the each data set. Viterbi-Training and EM-Training are approaches for machine-learning of the tokenizer based on the Viterbi algorithm and the EM algorithm, respectively. The numerical values in the table in FIG. 11 are the results (F1%±SD) of measuring the F1 values in evaluation data of the classification results. The bold numeric values are results that exceed the values in FIG. 1.

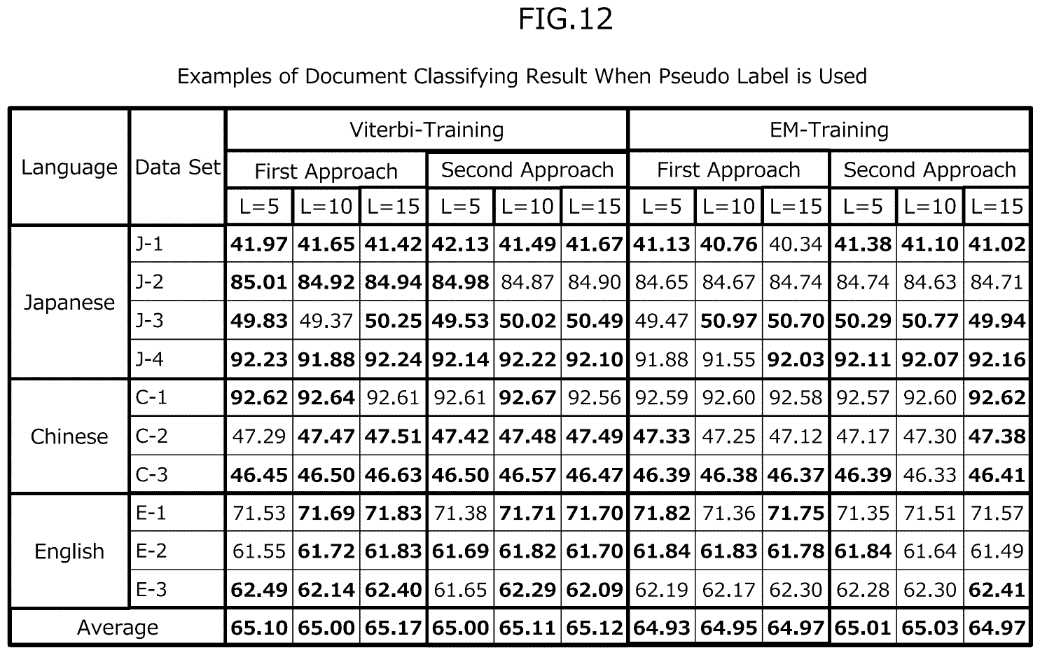

FIG. 12 is a diagram illustrating an example of a result of classification according to the training approach of the tokenizer 11 when a pseudo-label is used. FIG. 12 illustrates an example of the classification performed using the “first approach” and the “second approach” in the case where K-means clustering is used as an approach for generating a pseudo label and the cluster numbers L are L=5, L=10, and L=15. The other conditions are the same as in the case of FIG. 11.

As illustrated in FIGS. 11 and 12, it can be seen that the first approach and the second approach contribute to the performance improvement in the classification in any language of Japanese, Chinese, and English regardless of the approach for machine learning. As described above, the approach according to the one embodiment can keep the performance in inference quality of the downstream model above the trade-off level while the versatility of the tokenizer 11 is enhanced.

As described above, according to the approach of the one embodiment, in training the tokenizer 11 using training data set 21, the tokenization controller 31 trains the tokenizer 11 on the basis of the biasedness of the occurrence frequency in the multiple classes for each of the tokens included in the multiple tokenized text obtained by inputting the text 21a into the tokenizer 11 and tokenizing the text 21a in respective different tokenizing patterns corresponding to the text 21a.

With this configuration, in an application scene under a circumstance where the downstream model is not assured, for example, by using the class information 21b used in the downstream model and being based on the biasedness of the occurrence frequency occurrence in multiple classes for each token, it is possible to train the tokenizer 11 that is to contribute to the improvement in performance of the downstream model. Therefore, the tokenizer 11 can be appropriately adjusted regardless of the downstream model.

Further, for example, in the above-described approach that simultaneously optimizes (adjusts) the tokenization and the downstream model by activating the tokenizer and the downstream model in parallel, the tokenizer is optimized by a two-stage process of generating the tokenizer and simultaneously optimizing the tokenizer and the downstream model. For example, when the above-described approach is executed using a data set of 50000 sentences in size, it takes about one hour for the stage of generating and about six hours for the stage of simultaneous optimizing.

On the other hand, the first approach optimizes the tokenizer 11 by, as the training of the machine-learned (generated) tokenizer 11, a process of adjusting the scores of the tokenized text (score of each of the plurality of words) in the parameters of the tokenizer 11. The first approach assigns a score p′ (s) to the parameters of the generated tokenizer 11 at a later stage. Therefore, a processing time for estimating and assigning the score p′ (s) occurs in addition to the time of the stage of generating the tokenizer 11, but the additional processing time is only about one minute.

Further, the second approach optimizes the tokenizer 11 by, as the training of the tokenizer 11 that is being generated (i.e., in the middle of machine learning), a process of adjusting the scores of the tokenized text (score of each of the plurality of words) in the parameters of the tokenizer 11. The second approach estimates and assigns the score p′ (s) in the stage of generating the tokenizer 11, and therefore no processing time except for the time in the stage of generating the tokenizer 11 occurs.

As described above, also in cases where either of the first approach and the second approach is executed using a data set containing the 50000-sentence scale, the entire processing of the stage of simultaneous optimizing can be omitted as compared with the above-described approach, and therefore, the time can be shortened by about six hours. Therefore, the first approach and the second approach can significantly accelerate the optimization of the tokenizer 11 as compared with the above-described approach so that the tokenizer 11 that is to contribute to performance improvement of the downstream model can be trained in a short time.

### (D) Operating Example

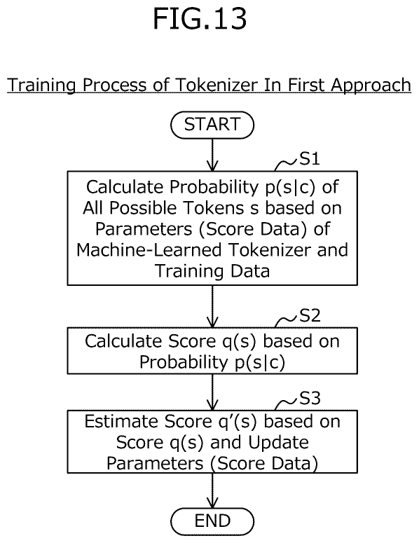

Next, description will now be made in relation to an example of operation performed in the server 1 configured as the above with reference to FIGS. 13-15.

### (D-1) Process of Training Tokenizer in First Method:

FIG. 13 is a flow diagram illustrating an example of operation of training the tokenizer 11 by the server 1 of the one embodiment in the first approach.

As illustrated in FIG. 13, the tokenization controller 31 calculates a probability p (s|c) for every possible token s on the basis of the parameters (score information 11b) generated for the machine-learned tokenizer 11 and training data included in the training data set 21 (Step S1). If the training data set 21 does not include the class information 21b, the pseudo-class generator 33 may generate a pseudo label, as the class information 21b, based on the text 21a.

The tokenization controller 31 calculates a score q(s) based on the probability p (s|c) (Step S2). Then, the tokenization controller 31 updates the parameter by estimating the score p′ (s) based on the score q(s) and reflecting the score p′ (s) in the score information 11c of the parameters (Step S3) and ends the process.

### (D-2) Process of Training Tokenizer in Second Method:

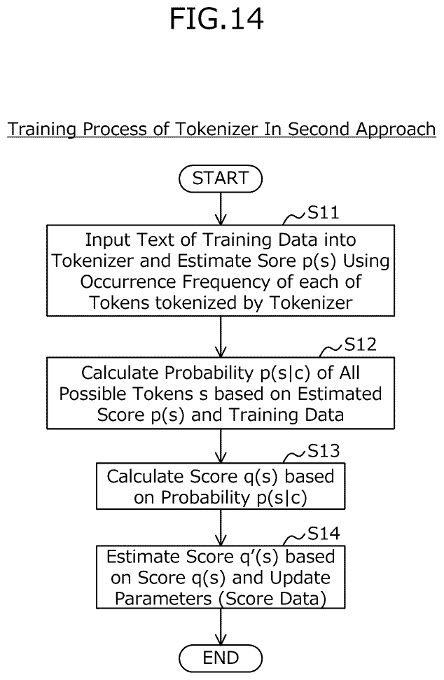

FIG. 14 is a flow diagram illustrating an example of operation of training the tokenizer 11 by the server 1 of the one embodiment in the second approach.

As illustrated in FIG. 14, the tokenization controller 31 estimates the score p(s) of a word obtained by inputting the text 21a of the training data included in the training data set 21 into the tokenizer 11 and tokenizing the inputted text 21a by the tokenizer 11, using the occurrence frequency of the word (step S11).

The tokenization controller 31 calculates a probability p(s|c) for every possible token s on the basis of the estimated score p(s) and the training data included in the training data set 21 (Step S12). If the training data set 21 does not include the class information 21b, the pseudo-class generator 33 may generate a pseudo label, as the class information 21b, based on the text 21a.

The tokenization controller 31 calculates a score q(s) based on the probability p (s|c) (Step S13). Then, the tokenization controller 31 updates the parameters by estimating the score p′ (s) based on the score q(s) and reflecting the score p′ (s) in the score information 11c of the parameters (Step S14) and ends the process.

### (D-3) Inference Process:

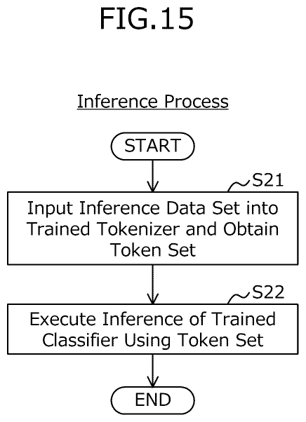

FIG. 15 is a flow diagram illustrating an example of operation of an inference process performed by the server 1 according to the one embodiment.

As illustrated in FIG. 15, the inference controller 32 inputs the inference data set 22 into the trained tokenizer 11 already trained in the first approach or the second approach, and obtains the token set 23 serving as the tokenized text (Step S21).

The inference controller 32 performs inference by the trained classifier 12 using the token set 23 (Step S22), obtains and outputs the inference result 24, and then the process ends. The inference controller 32 may evaluate the trained classifier 12 on the basis of the inference result 24. The evaluating result may be outputted to another computer along with the inference result 24.

### (E) Miscellaneous

The technique according to the one embodiment described above can be implemented by changing or modifying as follows.

For example, the elements 31 to 33 included in the server 1 illustrated in FIG. 5 may be merged in any combination or may each be divided.

Further, for example, the server 1 illustrated in FIG. 5 may have a configuration in which multiple apparatuses cooperate with each other via a network to achieve the respective process functions. As an example, the tokenizer 11, the classifier 12, the tokenization controller 31, the inference controller 32, and the pseudo-class generator 33 may be implemented by an application server or a Web server, and the storing region that stores the word information 11a, the score information 11b and 11c, and the data 21 to 24 may be implemented by a DB (Database) server. In this case, the processing function as the server 1 may be achieved by the web server, the application server, and the DB server cooperating with one another via a network.

As one aspect, the embodiment discussed herein can appropriately adjust the word splitter (tokenizer) that input s data into a machine learning model irrespective of the machine learning model.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer to execute a process comprising:
in training a word splitter with a training data set including a plurality of training data pieces each associating a letter string data piece and a class data piece representing one of a plurality of classes that the letter string data piece pertains with each other, the word splitter outputting split letter string data including a plurality of letter strings obtained by splitting an inputted letter string data piece, the split letter string data serving as input data to be inputted into a machine-learning model that performs an inference process,
training the word splitter based on biasedness of occurrence frequency in the plurality of classes for each of a first plurality of letter strings included in a plurality of pieces of the split letter string data, the plurality of pieces of the split letter string data being obtained by inputting the letter string data piece into the word splitter and by splitting the letter string data piece in respective different splitting patterns corresponding to the letter string data piece.

2. The non-transitory computer-readable recording medium according to claim 1, wherein
the training comprises adjusting, based on the biasedness of the occurrence frequency in the plurality of classes for each of the first plurality of letter strings included in the plurality of pieces of split letter string data, a score of each of the first plurality of letter strings, the score pertaining to parameters of the word splitter.

3. The non-transitory computer-readable recording medium according to claim 2, wherein
the adjusting comprises adjusting the score of each of the first plurality of letter strings such that a score of a letter string having a larger biasedness of the occurrence frequency in the plurality of classes comes to be higher among the first plurality of letter strings included in the plurality of pieces of split letter string data, and
the word splitter outputs, based on the parameters, split letter string data maximizing a total sum of the scores of the plurality of letter strings for each of the plurality of pieces of letter string data inputted into the word splitter.

4. The non-transitory computer-readable recording medium, according to claim 2, wherein
the adjusting is performed on the parameters of the word splitter after being trained.

5. The non-transitory computer-readable recording medium, according to claim 2, wherein
the adjusting is performed on the parameters when a machine learning process for the word splitter is being performed.

6. A computer-implemented method for information processing comprising:
in training a word splitter with a training data set including a plurality of training data pieces each associating a letter string data piece and a class data piece representing one of a plurality of classes that the letter string data piece pertains with each other, the word splitter outputting split letter string data including a plurality of letter strings obtained by splitting an inputted letter string data piece, the split letter string data serving as input data to be inputted into a machine-learning model that performs an inference process,
training the word splitter based on biasedness of occurrence frequency in the plurality of classes for each of a first plurality of letter strings included in a plurality of pieces of the split letter string data, the plurality of pieces of the split letter string data being obtained by inputting the letter string data piece into the word splitter and by splitting the letter string data piece in respective different splitting patterns corresponding to the letter string data piece.

7. The computer-implemented method according to claim 6, wherein
the training comprises adjusting, based on the biasedness of the occurrence frequency in the plurality of classes for each of the first plurality of letter strings included in the plurality of pieces of split letter string data, a score of each of the first plurality of letter strings, the score pertaining to parameters of the word splitter.

8. The computer-implemented method according to claim 7, wherein
the adjusting comprises adjusting the score of each of the first plurality of letter strings such that a score of a letter string having a larger biasedness of the occurrence frequency in the plurality of classes comes to be higher among the first plurality of letter strings included in the plurality of pieces of split letter string data, and
the word splitter outputs, based on the parameters, split letter string data maximizing a total sum of the scores of the plurality of letter strings for each of the plurality of pieces of letter string data inputted into the word splitter.

9. The computer-implemented method according to claim 7, wherein
the adjusting is performed on the parameters of the word splitter after being trained.

10. The computer-implemented method according to claim 7, wherein
the adjusting is performed on the parameters when a machine learning process for the word splitter is being performed.

11. An information processing device comprising:
a memory; and
a processor coupled to the memory, the processor being configured to perform a process comprising:
in training a word splitter with a training data set including a plurality of training data pieces each associating a letter string data piece and a class data piece representing one of a plurality of classes that the letter string data piece pertains with each other, the word splitter outputting split letter string data including a plurality of letter strings obtained by splitting an inputted letter string data piece, the split letter string data serving as input data to be inputted into a machine-learning model that performs an inference process,
training the word splitter based on biasedness of occurrence frequency in the plurality of classes for each of a first plurality of letter strings included in a plurality of pieces of the split letter string data, the plurality of pieces of the split letter string data being obtained by inputting the letter string data piece into the word splitter and by splitting the letter string data piece in respective different splitting patterns corresponding to the letter string data piece.

12. The information processing device according to claim 11, wherein the processor is further configured to adjust, based on the biasedness of the occurrence frequency in the plurality of classes for each of the first plurality of letter strings included in the plurality of pieces of split letter string data, a score of each of the first plurality of letter strings, the score pertaining to parameters of the word splitter in the training.

13. The information processing device according to claim 12, wherein
the processor is further configured to adjust the score of each of the first plurality of letter strings such that a score of a letter string having a larger biasedness of the occurrence frequency in the plurality of classes comes to be higher among the first plurality of letter strings included in the plurality of pieces of split letter string data in the adjusting, and
the word splitter outputs, based on the parameters, split letter string data maximizing a total sum of the scores of the plurality of letter strings for each of the plurality of pieces of letter string data inputted into the word splitter.

14. The information processing device according to claim 12, wherein
the processor is further configured to perform the adjusting on the parameters of the word splitter after being trained.

15. The information processing device according to claim 12, wherein
the processor is further configured to perform the adjusting on the parameters when a machine learning process for the word splitter is being performed.
